(19) United States
(12) Patent Application Publication
(10) Pub. No.: US 2020/0012288 A1
(43) Pub. Date: Jan. 9, 2020

(54) METHOD FOR DIVIDING MOVING SPACE AND MOVING ROBOT FOR MOVING DIVIDED MOVING SPACE

(71) Applicant: LG ELECTRONICS INC., Seoul (KR)

(72) Inventor: Tae Hyun KIM, Seoul (KR)

(73) Assignee: LG ELECTRONICS INC., Seoul (KR)

(21) Appl. No.: 16/578,069

(22) Filed: Sep. 20, 2019

(30) Foreign Application Priority Data
Aug. 12, 2019 (KR) 10-2019-0098222

(51) Int. Cl. G05D 1/02

(52) U.S. Cl. CPC G05D 1/0219; G05D 1/0221; G05D 2201/0215; G05D 2201/0203; G05D 1/0246

(57) ABSTRACT

The present disclosure divides a moving space where the mobile robot travels to allow the traveling mobile robot to travel. Further, when learning information of a movement obstacle which is machine-learned by the mobile robot corresponds to a target object around the mobile robot sensed by the mobile robot, the sensed target object can be excluded. That is, a map where the mobile robot moves is divided into a plurality of moving regions so that the robot completely travels one space and then travels another space instead of traveling a plurality of spaces, thereby preventing the degradation of the driving efficiency of the mobile robot. Further, the mobile robot can simultaneously travel and suck the foreign materials around the mobile robot.

### CROSS-REFERENCE TO RELATED APPLICATIONS

Pursuant to 35 U.S.C. § 119(a), this application claims the benefit of earlier filing date and right of priority to Korean Patent Application No. 10-2019-0098222, filed on Aug. 12, 2019, the contents of which are hereby incorporated by reference herein in its entirety.

### BACKGROUND

### 1. Technical Field

The present disclosure relates to a method for dividing a moving space which improves a movement efficiency of a mobile robot moving a moving space and a mobile robot which moves a divided moving space, and more particularly, to a technique which improves an efficiency of a space where a mobile robot moves by dividing the moving space by a polygon.

### 2. Description of the Related Art

The following contents described below are merely disclosed for the purpose of providing background information related to embodiments of the present disclosure, and the described contents are not always to be construed as a matter of the prior art.

Robots have been developed for industrial use, and have become responsible for parts of factory automation. Recently, the number fields in which robots are being applied are rapidly increasing, with medical robots and aerospace robots now being used, for example. In addition, robots for use in ordinary households are also being developed. Among the above-mentioned robots, a robot that is capable of autonomous traveling is referred to as a mobile robot.

A cleaning robot is a device that sucks dust or foreign materials from a target region to be cleaned while autonomously traveling around the target region, thereby cleaning the target region.

Specifically, the mobile robot can autonomously move. Further, a moving space where the mobile robot moves is arbitrarily divided to avoid obstacles while traveling and ensure a battery charging efficiency of the mobile robot.

Specifically, according to the existing method for dividing the moving space, a horizontal length of the moving space is divided by a minimum unit. The moving space divided as described above can be divided regardless of a shape of the moving space. Therefore, since the shape of the divided region is not uniform, there is a problem in that in order to move the moving space to suck dust or foreign materials, the mobile robot moves the same space several times.

Specifically, while the mobile robot moves the moving space to suck dust and foreign matters, the mobile robot can be interfered with an immovable object which is located in the moving space. In this case, when the moving space is divided without excluding the immovable object, the mobile robot cannot proceed the cleaning due to the collision with the immovable object.

That is, in order to ensure the movement efficiency of the mobile robot in the moving space, the moving space needs to be divided. According to a specific technique, Korean Patent No. 10-1667708 discloses “a robot cleaner and a control method thereof” which divides a space where a cleaning operation is performed based on a topology map and cleans each of a plurality of divided sectors.

However, in the related art “a robot cleaner and a control method thereof”, even though a technology of dividing a space which is cleaned by a robot cleaner into a plurality of sectors through the space and the space topology map is disclosed, a technique of uniformly dividing the moving space where the mobile robot moves or dividing the moving space in accordance with a shape of the moving space is not disclosed.

Specifically, a technology which divides the moving space excluding an immovable object when the interference with the immovable object located in the moving space is caused while the mobile robot moves the moving space to suck dust or foreign materials is not disclosed.

Further, Korean Patent No. 10-0911472” discloses “a mobile robot and an operating method thereof” which divides a cleaning region into a plurality of small regions in accordance with a measured distance or recognizes the cleaning region as one small region to clean each region, thereby effectively cleaning the cleaning region.

However, the “mobile robot and the operating method thereof” does not specifically disclose a technology which uniformly divides a moving space where the mobile robot moves or divides the moving space in accordance with a shape of the moving space using a technique which divides the cleaning region into small regions in accordance with distance data measured while the mobile robot travels or cleans the cleaning area by recognizing the cleaning area as one small region.

Moreover, in the related art “a mobile robot and an operating method thereof”, a technology which divides the moving space excluding the immovable object when the interference with the immovable object located in the moving space is caused while the mobile robot moves the moving space to suck dust or foreign materials is not disclosed.

Therefore, a technology which uniformly divides the moving space for efficient movement and divides the moving space excluding the immovable object when the interference with the immovable object located in the moving space is caused while the mobile robot moves the moving space to suck dust or foreign materials is required.

The above-described background arts are technical information acquired by the inventor for the contents to be disclosed or derived from the contents to be disclosed so that it cannot be referred to as known arts disclosed to the general public prior to the filing of the contents to be disclosed.

### RELATED ART DOCUMENT

### Patent Document

Related Art 1: Korean Patent No. 10-1667708 (Registered on Oct. 13, 2016)
Related Art 2: Korean Patent No. 10-0911472 (Registered on Aug. 3, 2009)

### SUMMARY OF THE INVENTION

An object of the present disclosure is to divide a moving space where a mobile robot is movable into a plurality of moving regions to enable the efficient movement of the mobile robot.

Another object of the present disclosure is to minimize an unnecessary motion generated when a mobile robot moves the moving space by dividing a moving space where the mobile robot moves into a plurality of polygons.

Another object of the present disclosure is to divide a moving space excluding a movement obstacle which cannot be moved from the moving space when the moving space where the mobile robot moves is divided to prevent collision and interference between the movement obstacle and the mobile robot.

Further, still another object of the present disclosure is to allow a mobile robot to learn the movement obstacle and then sense an object around the mobile robot and when the sensed object is a movement obstacle, divide the moving space based on learned data to minimize the collision and interference between the movement obstacle and the mobile robot, thereby allowing the mobile robot to efficiently move the moving space.

The object of the present disclosure is not limited to the above-mentioned objects and other objects and advantages of the present disclosure which have not been mentioned above can be understood by the following description and become more apparent from exemplary embodiments of the present disclosure. Further, it is understood that the objects and advantages of the present disclosure can be embodied by the means and a combination thereof in the claims.

In order to achieve the above-described object, a moving space dividing method and a mobile robot which moves the divided moving space according to an embodiment of the present disclosure relate to a technique which may divide a moving space where the mobile robot is movable into a plurality of moving regions to efficiently move the mobile robot.

Specifically, according to an aspect of the present disclosure, a moving space dividing method includes: receiving map information of a moving space; sensing a target object located in the moving space while moving the moving space; determining whether the target object, among the target objects, sensed based on a dataset labeled as a movement obstacle is a movement obstacle; and then dividing the moving space excluding the movement obstacle from the map.

Accordingly, the moving space where the mobile robot moves is divided into a plurality of polygons to minimize an unnecessary motion caused when the mobile robot moves the moving space.

According to the embodiment of the present disclosure, when the moving space is divided, if the first moving region of the plurality of moving regions divided from the moving space and the second moving region adjacent to the first moving region have a triangular shape or a quadrangular shape, the first moving region and the second moving region are merged and the merged region is classified as one region.

That is, depending on whether a wall surface is a curved line or a straight line with respect to a wall surface of the moving space, a number of times that the mobile robot moves or a cleaning time can vary so that the moving space is divided to have a polygonal shape, thereby preventing the traveling efficiency of the mobile robot from being degraded.

Specifically, in the moving space dividing method according to the embodiment of the present disclosure, the mobile robot moves and cleans the moving space and when the cleaning is performed, the mobile robot cleans one divided region and then moves to another region to clean another region.

Specifically, the mobile robot according to the embodiment of the present disclosure is set to clean another region after finishing the cleaning of one region, instead of simultaneously cleaning a plurality of regions, so that the degradation of the movement efficiency of the mobile robot can be minimized

That is, according to the embodiment of the present disclosure, when the cleaning is performed, a region having the largest size among the divided regions can be preferentially cleaned.

As described above, the mobile robot moves another moving region to clean the moving region after preferentially cleaning one moving region having a large size among the divided moving regions so that it is possible to prevent the mobile robot from being out of the current moving region where the mobile robot travels (cleans).

In the moving space dividing method according to the embodiment of the present disclosure, when it is determined whether to be the movement obstacle, image information of the target object is collected, it is confirmed that the target object is the movement obstacle by the user, and then a neural network is learned with a dataset labeled as a movement obstacle for the image information of the target object which is confirmed as the movement obstacle, and then a determining model for the movement obstacle can be generated.

That is, when the mobile robot travels, a program which can determine whether the sensed target object is a movement obstacle can be included.

Specifically, in the moving space dividing method according to the embodiment of the present disclosure, when it is determined whether to be a movement obstacle, after estimating a volume of the target object, if it is determined that the volume of the target object is equal to or larger than a predetermined range, based on the collected image information of the target object, the target object can be determined as the movement obstacle.

That is, when the surroundings of the mobile robot are sensed, if the sensed target object corresponds to information of an immovable object in the information stored in advance, the sensed target object is determined as the movement obstacle.

According to another aspect of the present disclosure, a mobile robot includes: a main body of the mobile robot; a driver which moves the main body; a sensor which is equipped in the main body, moves a moving space, and senses a target object around the mobile robot; a moving region setting unit which divides the moving space excluding the movement obstacles into a plurality of moving regions having any one of shapes of a quadrangular shape or a triangular shape based on the dataset labeled as the movement obstacle of the sensed target objects; a memory in which the dataset for the movement obstacle is stored; and a controller which communicates with the memory, the driver, and the moving region setting unit to control the driver.

Accordingly, the moving space where the mobile robot moves is divided into a plurality of polygons to minimize an unnecessary motion caused when the mobile robot moves the moving space.

Further, while moving space where the mobile robot moves is divided, the moving space where the mobile robot moves is divided excluding a movement obstacle which cannot be moved, from the moving space, to prevent collision and interference between the movement obstacle and the mobile robot.

If the first moving region of the plurality of moving regions divided from the moving space and the second moving region adjacent to the first moving region have a triangular shape or a quadrangular shape, the moving region setting unit of the mobile robot of the present disclosure may merge the first moving region and the second moving region and classify the merged region as one region.

Further, according to the embodiment of the present disclosure, when the mobile robot moves the moving space to clean, after finishing the cleaning of one region, the mobile robot moves another region to clean.

Specifically, the mobile robot according to the embodiment of the present disclosure is set to clean another region after finishing the cleaning of one region, instead of simultaneously cleaning a plurality of regions, so that the degradation of the movement efficiency of the mobile robot can be minimized

Further, the mobile robot of the present disclosure can preferentially clean a region having the largest size among the divided regions.

As described above, the mobile robot moves another moving region to clean the moving region after preferentially cleaning one moving region having a large size among the divided moving regions so that it is possible to prevent the mobile robot from being out of the current moving region where the mobile robot cleans.

Other aspects, features, and advantages other than those described above will become apparent from the following drawings, claims, and the detailed description of the present invention.

According to the present disclosure, when the mobile robot moves the moving space where the cleaning is performed, the mobile robot moves arbitrarily divided moving spaces to easily perform the cleaning, thereby improving a movement efficiency of the mobile robot.

That is, the mobile robot for cleaning can be configured to suck foreign materials while moving a divided moving space. In this case, when the moving space is divided into spaces having a polygonal shape, the mobile robot travels with respect to the divided space so that it is prevented from sucking a target object while moving various regions.

Further, according to the present disclosure, when a target object having a predetermined weight or more, such as a table or home appliances, is located in the moving space, a sensor determines the sensed target object as an immovable object. The immovable object determined as described above is determined as an area where the cleaning cannot be performed so that a region setting unit can divide the moving region excluding a region around the immovable object. Specifically, in order to avoid an object through a sensor whenever the mobile robot travels the moving space, it takes a time to recognize the object and determine whether the object is a target object to be avoided. Therefore, a route to be cleaned by the mobile robot can be set in advance by excluding an immovable object from a map in advance.

Further, according to the present disclosure, when the target object sensed by the sensor is a movement obstacle, the moving region from which the movement obstacle is excluded can be divided into a plurality of polygons.

That is, according to the embodiment of the present disclosure, when map information is acquired, position information of the movement obstacle is acquired and the movement obstacle is removed from a map to divide the moving space into a plurality of moving regions. In this case, when a movement obstacle which is not excluded from the map is disposed in the moving region and the disposed movement obstacle is sensed by the sensor, according to the embodiment of the present disclosure, the moving region is divided by excluding the movement obstacle from the moving region.

Accordingly, information about the movement obstacle in the moving region is acquired in real time and the moving space is divided based on the acquired information about the movement obstacle so that the interference and the collision between the movement obstacle and the mobile robot are minimized to allow the mobile robot to efficiently move the moving space.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a view illustrating an embodiment in which a mobile robot according to an embodiment of the present disclosure is implemented;

FIG. 2 is a schematic block diagram of a mobile robot according to an embodiment of the present disclosure;

FIG. 3 is a view illustrating an embodiment which divides a moving space where a mobile robot according to an embodiment of the present disclosure is movable;

FIG. 4 is a view illustrating an example which excludes a movement obstacle when the movement obstacle is located in a moving space where a mobile robot according to an embodiment of the present disclosure is movable;

FIG. 5 is a view for explaining a process of dividing a moving space where a mobile robot according to an embodiment of the present disclosure is movable;

FIG. 6 is a view illustrating an example which divides a moving space where a mobile robot moves when the movement obstacle is located in a moving space where a mobile robot according to an embodiment of the present disclosure is movable;

FIG. 7 is a flowchart for explaining a process of dividing a moving space where a mobile robot according to an embodiment of the present disclosure is movable; and

FIG. 8 is a flowchart for specifically explaining a process of determining a movement obstacle of FIG. 7.

### DETAILED DESCRIPTION

Hereinafter, the present disclosure will be described in detail with reference to the accompanying drawings. However, the present disclosure can be implemented in many different forms and should not be construed as being limited to the embodiments set forth herein. In order to clearly describe the present disclosure, parts that have no connection with the description are omitted from the embodiments. However, this does not mean that the omitted elements are unnecessary for embodying an apparatus or a system to which the idea of the present disclosure is applied. Further, like reference numerals refer to the like or similar elements throughout the specification.

In the following description, although the terms “first”, “second”, and the like can be used herein to describe various elements, these elements should not be limited by these terms. These terms can be only used to distinguish one element from another element. Further, as used herein, the singular forms “a,” “an,” and “the” can be intended to include the plural forms as well, unless the context clearly indicates otherwise.

In the following description, it will be understood that the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

Hereinafter, a mobile robot of the present disclosure which moves a moving space which is divided for efficient movement will be described in detail.

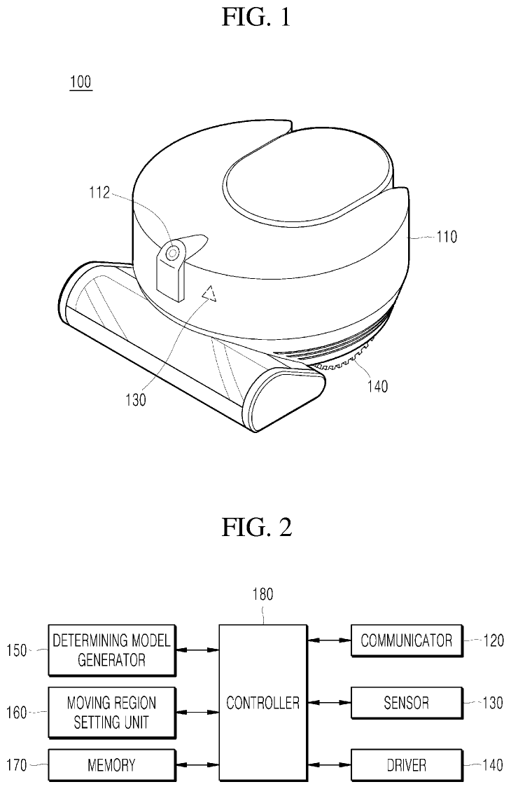

FIG. 1 is a view illustrating an embodiment in which a mobile robot according to an embodiment of the present disclosure is implemented and FIG. 2 is a schematic block diagram of a mobile robot according to an embodiment of the present disclosure.

As an example of a mobile robot according to an embodiment of the present disclosure, a cleaning robot which autonomously travels will be described. However, the mobile robot can also operate in a semi-autonomous or manual mode, as well as the autonomous traveling mode. Further, a mobile robot according to an embodiment of the present disclosure which enables machine learning and autonomous traveling can be any one of robots which can operate in an autonomous or semi-autonomous mode in addition to the cleaning robot.

As an example of a mobile robot 100 according to an embodiment of the present disclosure, an autonomous traveling robot which sucks a target object (for example, dust or wastes) located in front of the mobile robot 100 while moving along a moving space will be described.

In order to perform cleaning by the mobile robot 100, a moving space where the mobile robot 100 moves can be divided. Specifically, the division of moving space refers to an operation which divides a moving space (for example, offices or home) having various shapes into a plurality of regions and cleans one region of the divided regions and then cleans a next region.

In this case, in order to divide the moving space into a plurality of regions, the moving space can be divided with respect to a shape (for example, a quadrangle or a circle) of the moving space and a connection path connecting spaces and a reference of dividing the moving space can vary depending on a condition.

The mobile robot 100 according to the embodiment of the present disclosure can be configured to suck foreign materials while moving the divided moving space. To this end, as described above, the moving space can be automatically divided in accordance with a predetermined condition. In this case, the moving space can be divided to have a quadrangular shape or a triangular shape with respect to the shape of the moving space and the connection path connecting spaces, excluding an immovable object such as an object having a large volume and an object having a predetermined weight or larger. Accordingly, a movement of the mobile robot 100 can be minimized and the foreign materials can be sucked with the minimum movement.

Specifically, the mobile robot 100 can be configured to include a main body 110, a driver 140, a sensor 130, a moving region setting unit 160, a memory 170, and a controller 180.

The main body 110 forms an outer appearance of the mobile robot 100 and can be formed by any one of various shapes such as a circle or a polygon. The shape of the main body 110 can vary depending on the condition.

Further, the main body 110 can include a sucker 114 which sucks target objects dispersed in the moving space, such as dust or foreign materials. Further, the main body 110 can be configured to include a suction device (not illustrated) for sucking a target object through the sucker 114 and a dust collector which collects the sucked dust.

Moreover, the main body 110 can be equipped with a camera 112 which detects a front side. The camera 112 photographs the surroundings of the mobile robot 100 and an image or image information photographed by the camera 112 can be transmitted to the sensor 130 to be described below.

In the meantime, the main body 110 can further include a battery (not illustrated). The battery can supply power required for overall operations of the mobile robot 100 in addition to the driver 140 to be described below. When the battery is discharged, the battery can be charged. For example, if the battery is discharged, the mobile robot 100 moves to a charging dock (not illustrated) installed in the moving space to charge the battery. Specifically, the mobile robot 100 can be configured to detect a position of the charging dock by itself while traveling to return to the charging dock.

The driver 140 can include at least one driving wheel to allow the main body 110 to rotate and move in the moving space. The driving wheel can be installed on one surface of the main body 110, but the structure where the driving wheel is installed can vary depending on the condition. In the meantime, the main body 110 or the driver 140 may include a separate driving motor which drives the driving wheel.

The sensor 130 is installed in the main body 110 and senses the target object around the mobile robot 100 when the mobile robot 100 moves in the moving space. In this case, the mobile robot 100 can determine whether the object sensed by the sensor 130 is a movable object or an immovable object. Further, the sensor 130 can determine whether the sensed object is an unsuckable object. When the unsuckable object is sensed among the sensed objects, a program can be set in advance such that the mobile robot 100 does not suck the sensed object.

Specifically, the sensor 130 can radiate a laser sensor, for example, among electromagnetic waves. When a volume of the target object or a type (for example, a liquid or a solid) of the target object through a returning electromagnetic wave formed by a laser which is radiated toward the target object to be reflected by the target object to return to the sensor 130 is measured and the measured volume of the target object is a predetermined size or more in comparison with the information of movement obstacle which is input in advance, the target object can be determined as an immovable object.

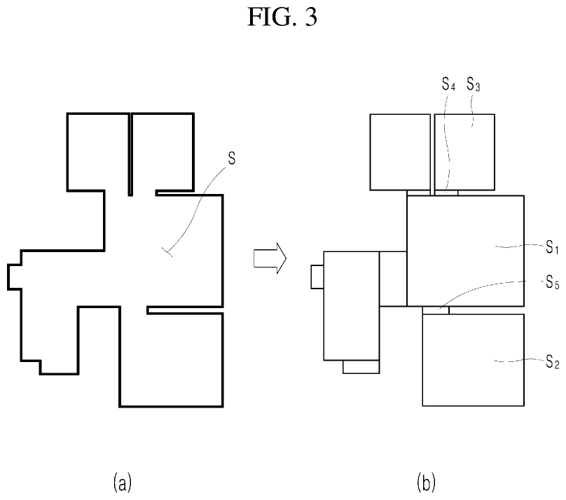

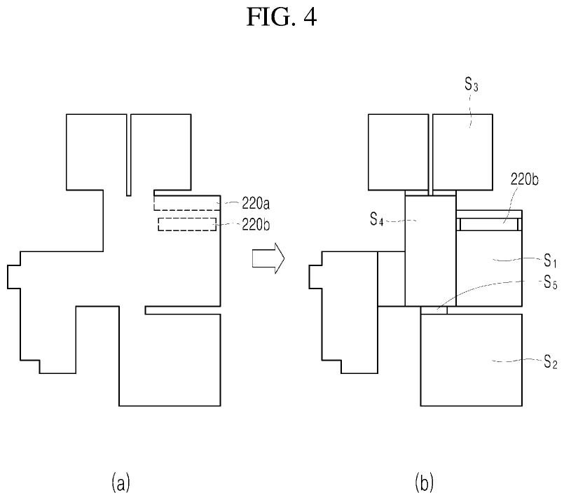

In the meantime, the moving space S (see FIG. 4) where the mobile robot 100 moves can be divided into a plurality of moving regions S₁ to S₄ (see FIG. 3) having a predetermined size or larger. That is, the moving space is partitioned into a plurality of regions. As the moving space is partitioned into a plurality of regions, the mobile robot 100 cleans any one moving region and then moves to another region to clean the region. As described above, the mobile robot 100 cleans one moving region and then cleans another region so that the mobile robot 100 moves different regions to clean the other region. Therefore, unnecessary movement can be prevented.

In order to divide the moving space S (see FIG. 3), the moving space excluding the movement obstacle can be divided into a plurality of moving regions through the moving region setting unit 160 based on a dataset labeled as a movement obstacle among the target objects sensed by the sensor 130.

The moving region setting unit 160 will be described in more detail. The moving region setting unit 160 can divide the moving space into a plurality of regions based on indoor map information stored in the memory 170. In this case, the plurality of divided regions can have a triangular shape or a quadrangular shape. Hereinafter, in the embodiment of the present disclosure, an example of dividing the moving region based on a quadrangular shape will be described. However, when the moving region is divided, the moving space can be divided to have various shapes such as a circular shape, a triangular shape, and a quadrangular shape in consideration of a condition such as an entire size of the moving space or a structure of a wall surface (for example, any one of a curved line and a straight line).

As described above, when the moving space is divided into a plurality of moving regions by the moving region setting unit 160, if an interferable object is the immovable object (for example, an object having a predetermined volume or lager and/or an object having a predetermined weight or more) in the moving space, the moving space can be divided into a plurality of moving regions excluding an area of the immovable object from the moving space.

That is, the immovable object in the moving space is excluded from the map. Therefore, when the movement obstacle which cannot be moved is excluded from the map, an arbitrary reference line is formed in the vicinity of the immovable object to exclude the object from the map with respect to the reference line. The formed reference line can be changed in accordance with the condition of the invention, but exemplarily, the reference line can be desirably formed along a border line of the object.

Generally, in order to avoid an object through a sensor whenever the mobile robot 100 travels the moving space, it takes a time to recognize the object and determine whether the object is a target object to be avoided. Therefore, a route to be cleaned by the mobile robot 100 can be set in advance by excluding an object which cannot be moved from a map in advance.

To this end, a dataset which is labeled as a movement obstacle which cannot be moved when the mobile robot 100 moves can be stored in advance in the memory 170. The dataset can be, for example, an image of home appliances, a sofa, and a refrigerator.

Prior to cleaning the moving space based on the stored dataset, the mobile robot 100 can sense a target object through the camera 112 while traveling the moving space. When the sensed target object matches the stored dataset, the sensed target object is determined as a movement obstacle and is excluded from a map which stores a position of the determined movement obstacle and then the moving space is divided into a plurality of moving regions through the moving region setting unit 160.

To the contrary, the memory 170 can further include a determining model generator 150 which stores and learns a machine learning model trained with the dataset labeled as the movement obstacle which cannot be moved. That is, a computer-readable program which can determine whether the target object sensed by the sensor 130 is a movement obstacle can be stored in the memory 170.

To this end, the mobile robot 100 travels the moving space to sense the target object disposed in the moving space through the camera 112 and the sensor 130. Among the target objects sensed as described above, a target object which is determined as a movement obstacle is stored in the memory 170 to be trained and then excluded from the map. Thereafter, the moving space which is divided into the plurality of moving regions can be cleaned.

As described above, the memory 170 records or stores information about the movement obstacle and may include a volatile or non-volatile recording medium. The recording medium stores data readable by the controller 180 and can include a hard disk drive (HDD), a solid state disk (SSD), silicon disk drive (SDD), ROM, RAM, CD-ROM, a magnetic tape, a floppy disk, and an optical data storage device. In the present embodiment, information stored in the memory 170 can be described in accordance with situations suitable for a context.

In the meantime, information about the movement obstacle stored in the memory 170 can be supplied from a server (not illustrated). The server can include a web server or an application which remotely controls the mobile robot 100 through a communicator 120 which communicates with an application or a web browser installed in the mobile robot 100.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed Specifically, the machine learning can be a technology for researching and constructing a system for learning, predicting, and improving its own performance based on empirical data and an algorithm for the same. Machine learning algorithms, rather than only executing rigidly-set static program commands, can be used to take an approach that builds models for deriving predictions and decisions from inputted data.

Machine learning paradigms, in which the ANN operates, can include unsupervised learning and supervised learning.

Deep learning, which is a subfield of machine learning, enables data-based learning through multiple layers. Deep learning can represent a set of machine learning algorithms that extract core data from a plurality of data sets as the number of layers in increases.

Deep learning structures can include an artificial neural network (ANN), and can include a convolutional neural network (CNN), a recurrent neural network (RNN), a deep belief network (DBN), and the like. The deep learning structure according to the present embodiment can use various structures well known in the art. For example, the deep learning structure according to the present disclosure can include a CNN, an RNN, a DBN, and the like. The RNN is widely used in natural language processing, and can be effectively used to process time-series data that changes over time, and can construct an ANN structure by progressively extracting higher level features through multiple layers. The DBN can include a deep learning structure that is constructed by stacking the result of restricted Boltzman machine (RBM) learning in multiple layers. A DBN has the number of layers formed by repeating RBM training. CNN includes a model mimicking a human brain function, built on the assumption that when a person recognizes an object, the brain extracts basic features of the object and recognizes the object based on the results of complex processing in the brain.

Further, the artificial neural network can be trained by adjusting weights of connections between nodes (if necessary, adjusting bias values as well) so as to produce a desired output from a given input. Also, the artificial neural network can continuously update the weight values through learning. Furthermore, methods such as back propagation can be used in training the artificial neural network.

In the meantime, an artificial neural network can be loaded in the mobile robot 100 of an embodiment of the present disclosure and cleaning can be performed by a machine learning-based mobile robot which has information about the movement obstacle as input data.

Referring to the drawings again, when the moving space is divided into a plurality of moving regions by the moving region setting unit 160, if among the plurality of divided moving regions, a first moving region and a second moving region adjacent to the first moving region have a triangular shape or a quadrangular shape, the moving region setting unit 160 may merge the first moving region and the second moving region and classify the merged regions as one region.

As described above, the moving region is a region where the mobile robot 100 travels and cleans. When the moving region is divided to have a quadrangular shape which is similar to an internal structure of an office or a home, the moving region can be relatively divided to be large. That is, when one moving region is set, the set one moving region can be formed to have a maximum-sized quadrangular shape. As described above, the first moving region and the second moving region which are adjacent different regions are merged in order to form a maximum-sized quadrangular shape.

As described above, one moving region is set to have a maximum-sized quadrangular shape so that the mobile robot 100 can clean without moving different spaces several times. Specifically, when the mobile robot 100 moves and cleans the moving space, the mobile robot 100 moves to another region to clean the other region after finishing the cleaning of one region. That is, a size of one moving region which needs to be cleaned by the mobile robot 100 at one time is formed as large as possible so that the number of movement times that the mobile robot 100 moves different moving regions is minimized

Further, when the mobile robot 100 moves and cleans the moving space, the mobile robot 100 can preferentially clean a region having the largest size among the divided regions. For example, when the divided first moving region is larger than the second moving region, the mobile robot preferentially cleans the first moving region.

The controller 180 may communicate with the driver 140, the memory 170, and the moving region setting unit 160 to control the driver 140.

That is, prior to cleaning the moving space based on the dataset stored in the memory 170, the mobile robot 100 can sense a target object through the camera 112 while traveling the moving space. When the sensed target object matches the stored dataset, the sensed target object is determined as a movement obstacle and is excluded from a map which stores a position of the determined movement obstacle and then the moving space is divided into a plurality of moving regions through the moving region setting unit 160.

That is, a route to be cleaned by the mobile robot 100 can be preset by excluding an object which cannot be moved from a map in advance. Thereafter, the driver 140 is driven to perform the cleaning by the mobile robot 100 along the set route.

Here, the controller 180 can include any types of devices which are capable of processing data such as a processor. Here, a processor can refer to a data processing device embedded in hardware which has a physically configured circuit to perform a function expressed by a code or a command included in a program. Examples of the data processing device built in a hardware include, but are not limited to, processing devices such as a microprocessor, a central processing unit (CPU), a processor core, a multiprocessor, an application-specific integrated circuit (ASIC), a field programmable gate array (FPGA), and the like.

FIG. 3 is a view illustrating an embodiment which divides a moving space where a mobile robot according to an embodiment of the present disclosure is movable. In the following description, a description of the common parts previously described with reference to FIGS. 1 and 2 will be omitted.

Referring to FIG. 3, the mobile robot 100 acquires information about a size of the entire moving space and a structure of a wall surface of the moving space while traveling the moving space S and stores the information in the memory 170. Specifically, the information about the moving space can refer to map information of an indoor space such as a home or an office. Specifically, the information about the moving space can be information about a shape of an indoor wall surface (for example, a shape such as a curved line or a straight line) or an entire size of the space.

The moving space can be divided into a plurality of moving regions S₁ to S₅ based on the moving space information stored as described above. The divided moving regions can be a space where the mobile robot travels and cleans.

Specifically, when the moving region S₁ is the largest region in the entire moving space, the mobile robot 100 can preferentially clean the moving region S₁. Thereafter, the mobile robot 100 can sequentially clean the moving region S₂ which is smaller than the moving region S₁. In this case, when a movement path S₅ (see FIG. 3) between the moving region S₁ and the moving region S₂ is formed, the mobile robot 100 moves from the moving region S₁ to the moving region S₂ to clean the movement path S₅.

In the meantime, in the embodiment of the present disclosure, although an embodiment in which the mobile robot 100 travels in the order of a size of the moving region has been described as an example, the moving regions are sequentially set from a region adjacent to an entrance door (not illustrated) of the moving space to a remote region and the cleaning can be performed in accordance with the set moving regions.

As described above, the mobile robot 100 cleans while traveling along the moving space so that it is possible to prevent the mobile robot 100 from being out of the current moving region where the mobile robot 100 travels (or cleans). For example, an unnecessary movement of the mobile robot 100 where the mobile robot 100 irregularly moves between the moving region S₃ and the moving region S₂ is minimized to clean the moving space with a minimum movement.

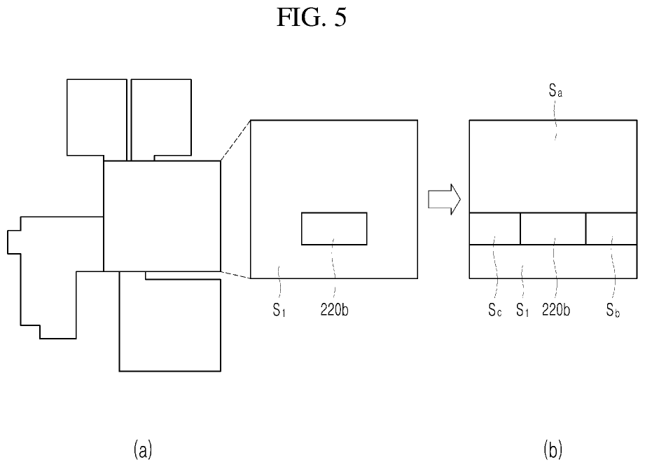

FIG. 4 is a view illustrating an example which excludes a movement obstacle when the movement obstacle is located in a moving space where a mobile robot according to an embodiment of the present disclosure is movable and FIG. 5 is a view for explaining a process of dividing a moving space where a mobile robot according to an embodiment of the present disclosure is movable. Hereinafter, a description of the common parts previously described with reference to FIGS. 1 to 4 will be omitted.

Referring to the drawings, the mobile robot 100 moves the moving space S (see FIG. 3) to acquire information about a size of the entire moving space and a structure of a wall surface of the moving space.

In this case, in the moving space, movement obstacles 220a and 220b which are immovable objects can be disposed. Information about the movement obstacles which are immovable objects can be stored in advance in the mobile robot 100 or acquired when the mobile robot 100 travels the moving space to acquire the map information. The movement obstacle can refer to an object having a predetermined volume or larger or a predetermined weight or higher, such as a table or home appliances disposed indoor.

After acquiring the information about the movement obstacle together with the map information, the area where the movement obstacle is disposed can be excluded from the map. That is, the area where the movement obstacle is disposed is excluded since a space where the mobile robot 100 cannot travel. Generally, in order to avoid an object through a sensor whenever the mobile robot 100 travels the moving space, it takes a time to recognize the object and determine whether the object is a target object to be avoided. Therefore, a route to be cleaned by the mobile robot 100 can be preset by excluding an object which cannot be moved from a map in advance to improve cleaning efficiency.

As described above, when the area where the movement obstacle is disposed is removed from the moving space, the moving space from which the movement obstacle is excluded can be divided into a plurality of moving regions. Specifically, referring to FIG. 5, when the movement obstacle 220b is disposed in the moving region S2 (see FIG. 4), the mobile robot 100 can divide the moving region excluding the area where the movement obstacle 220b is disposed. In this case, the remaining space excluding the area where the movement obstacle 220b is disposed from the map is divided.

The moving regions divided as described above can be a region where the mobile robot travels and cleans. Referring to FIG. 4, the moving region S₁ is divided by the movement obstacle 220b so that the moving region S₂ becomes the largest region in the entire moving space. Accordingly, the mobile robot 100 can preferentially clean the moving region S₂. Thereafter, the mobile robot 100 can sequentially clean moving regions which are smaller than the moving region S₂.

In this case, the moving region S₁ is divided by the movement obstacle 220b of FIG. 4 to be divided into a moving region S₄ and moving regions Sa, Sb, and Sc. In this case, even though the moving region Sc is merged with the moving region S₄, the merged region does not have a quadrangular shape or a triangular shape so that the moving region Sc and the moving region S4 can be distinguished as different moving regions.

Specifically, a size of the moving region S₄ is larger than a size of the moving region Sc so that the mobile robot 100 can be set to preferentially clean the moving region S4.

As described above, the mobile robot 100 moves another moving region to clean the moving region after preferentially cleaning one moving region so that it is possible to prevent the mobile robot 100 from being out of the current moving region where the mobile robot 100 travels (or cleans). For example, an unnecessary movement of the mobile robot 100 where the mobile robot 100 irregularly moves between the moving region S3 and the moving region S₂ is minimized to clean the moving space with a minimum movement.

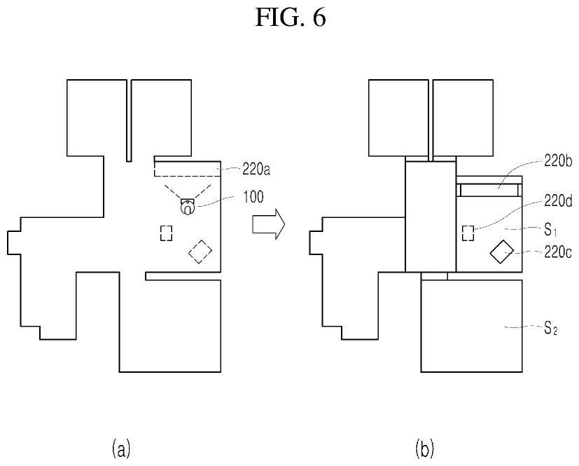

FIG. 6 is a view illustrating an example which divides a moving space where a mobile robot moves when the movement obstacle is located in a moving space where a mobile robot according to an embodiment of the present disclosure is movable. Hereinafter, a description of the common parts previously described with reference to FIGS. 1 to 5 will be omitted.

Referring to the drawing, the mobile robot 100 travels the moving space S (see FIG. 3) to acquire map information of the moving space and also acquires information about the movement obstacles 220a and 220b which are immovable objects.

Thereafter, the moving space excluding the movement obstacles 220a and 220b can be divided into a plurality of regions. In this case, information about a movable object 240 can be obtained from objects collected by the mobile robot 100. The movable object can be, for example, any one of a box, a movable object with wheels at a lower portion, and an object which is measured to have a predetermined weight or lighter. The movable object can be an object which can avoid the mobile robot 100 or change its position while the mobile robot 100 travels.

Therefore, the mobile robot 100 can be set so as not to exclude a region of the movable objects from the map. That is, when the information about the movable object stored in the memory 170 and an object sensed by the sensor 130 correspond to information about the movable object, the object sensed by the sensor 130 can change its position if necessary while the mobile robot 100 travels the moving space so that the object sensed by the sensor 130 is not a target which will be excluded from the map.

In this case, the information about the movable object 220c is stored in the memory 170 and then a location where the movable object 220 is located can be determined as a cleanable region. Accordingly, the mobile robot 100 can be set to return to the location where the movable object 220c is located during the cleaning process. Alternatively, an alarm is issued in the vicinity of the movable object 220c to cause the user to move the movable object 220c.

As described above, the movement obstacle and the movable object are distinguished to clean by the mobile robot 100 so that even though the interference (for example, collision) between the movable object and the mobile robot 100 is generated, the mobile robot 100 can suck the target object (for example, dust and foreign material) without stopping traveling. Therefore, it is possible to prevent the cleaning efficiency of the mobile robot 100 from being degraded.

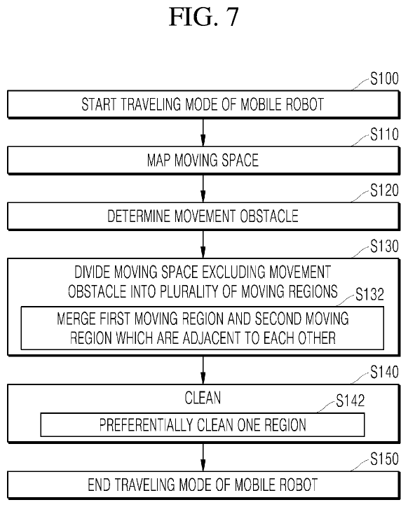

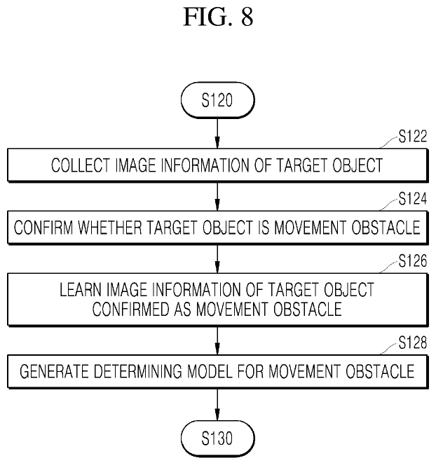

FIG. 7 is a flowchart for explaining a process of dividing a moving space where a mobile robot according to an embodiment of the present disclosure is movable and FIG. 8 is a flowchart for specifically explaining a process of determining a movement obstacle of FIG. 7. Hereinafter, a description of the common parts previously described with reference to FIGS. 1 to 6 will be omitted.

The mobile robot 100 according to an embodiment of the present disclosure is a device which travels the moving space to automatically suck a target object located around the mobile robot 100, such as dust and foreign materials.

In order to travel the moving space, the mobile robot 100 can be configured to divide the moving space into a plurality of moving regions, and travel and clean one of the divided moving regions and then move another adjacent moving region to clean the adjacent moving region.

Specifically, referring to FIG. 7, a moving space where the mobile robot can travel is mapped to acquire map information about the moving space in steps S100 and S110.

When the mobile robot 100 travels, the mobile robot can sense a target object around the mobile robot 100. For example, an object sensed by the mobile robot 100 is determined whether to be a movable object or an immovable object in step S120.

When the sensed object is a movement obstacle, the moving space excluding the movement obstacle can be divided into a plurality of moving regions based on a dataset which is labeled as a movement obstacle stored in the memory 170 in step S130.

Specifically, the plurality of divided regions can have a triangular shape or a quadrangular shape. Hereinafter, in the embodiment of the present disclosure, an example of dividing the moving region based on a quadrangular shape will be described. However, when the moving region is divided, the moving space can be divided to have various shapes such as a circular shape, a triangular shape, and a quadrangular shape in consideration of a condition such as an entire size of the moving space or a structure of a wall surface (for example, any one of a curved line and a straight line).

As described above, when the moving space is divided into a plurality of moving regions, a movement obstacle disposed in the moving space is excluded from the moving space to be divided into a plurality of moving regions.

That is, the immovable object is excluded from the map. Generally, in order to avoid an object through a sensor whenever the mobile robot 100 travels the moving space, it takes a time to recognize the object and determine whether the object is a target object to be avoided. Therefore, a route to be cleaned by the mobile robot 100 can be set in advance by excluding an object which cannot be moved from a map in advance.

To this end, a dataset which is labeled as a movement obstacle which cannot be moved when the mobile robot 100 moves can be stored in advance in the memory 170 and it is determined whether the stored dataset matches the sensed movement obstacle.

Alternatively, the memory 170 can store and learn a machine learning model trained with the dataset labeled as the movement obstacle which cannot be moved.

Specifically, referring to FIG. 8, when it is determined whether to be a movement obstacle, image information of a target object may be collected in step S122 and it is confirmed that the collected object is a movement obstacle by the user in step S124. In this case, the user can confirm that the collected target object is a movement obstacle using a portable terminal, a wearable device, or the like of the user.

Thereafter, a neural network can be trained with a dataset labeled as a movement obstacle with respect to the image information of the object confirmed as the movement obstacle in step S126. That is, a computer-readable program which can determine whether the sensed target object is a movement obstacle can be stored in the memory 170.

A determination model for the movement obstacle learned as described above can be generated and it is determined whether the target object sensed by the mobile robot 100 is a movement obstacle based on the generated determination model in step S128.

In the meantime, when the moving space is divided into a plurality of moving regions, if among the plurality of divided moving regions, a first moving region and a second moving region adjacent to the first moving region have a triangular shape or a quadrangular shape, the moving region setting unit 160 may merge the first moving region and the second moving region and classify the merged regions as one region in step S132.

That is, when one moving region is set, the set moving region can be formed to have a maximum-sized quadrangular shape. As described above, the first moving region and the second moving region which are adjacent different regions are merged in order to form a maximum-sized quadrangular shape.

As described above, one moving region is set to have a maximum-sized quadrangular shape so that the mobile robot 100 can clean without moving different spaces several times in steps S140 and 142. Specifically, when the mobile robot 100 moves and cleans the moving space, the mobile robot 100 moves to another region to clean the region after finishing the cleaning of one region. That is, a size of one moving region which needs to be cleaned by the mobile robot 100 at one time is formed as large as possible so that the number of movement times that the mobile robot 100 moves different moving regions is minimized

Further, when the mobile robot 100 moves and cleans the moving space, the mobile robot 100 can preferentially clean a region having the largest size among the divided regions. For example, when the divided first moving region is larger than the second moving region, the mobile robot preferentially cleans the first moving region.

In the meantime, when it is determined whether to be a movement obstacle, the mobile robot 100 radiates an electromagnetic wave to determine whether to be a movement obstacle.

Specifically, a laser sensor equipped in the mobile robot 100 may be radiated toward the target object and a volume of the target object can be estimated by a returning electromagnetic wave formed by the radiated laser which is reflected by the target object. The estimated volume of the target object is compared with information about the movement obstacle input in advance and if the estimated volume of the target object is a predetermined size or more in comparison with the information of the movement obstacle input in advance, the target object can be determined as an immovable object.

As described above, the moving space is divided into a plurality of moving regions so that the mobile robot 100 will clean while not moving a plurality of spaces. That is, the mobile robot preferentially travels and cleans one divided region so that when one region is completely cleaned, the mobile robot 100 moves to another region to clean.

Specifically, the mobile robot 100 is set to clean another region after finishing the cleaning of one region, instead of simultaneously cleaning a plurality of regions, so that the degradation of the movement efficiency of the mobile robot 100 can be minimized

As described above, the moving space is divided into a plurality of moving regions to travel the divided moving regions so that the movement mode of the mobile robot 100 ends in step S150.

The embodiments of the present disclosure described above can be implemented through computer programs executable through various components on a computer, and such computer programs can be recorded in computer-readable media. Examples of the computer-readable medium can include magnetic media such as a hard disk drives (HDD), floppy disks and a magnetic tapes, optical media such as CD-ROMs and DVDs, magneto-optical media such as floptical disks, or hardware devices such as ROMs, RAMs, and flash memories specifically configured to store and execute program commands

Meanwhile, the computer programs can be those specially designed and constructed for the purposes of the present disclosure or they can be of the kind well known and available to those skilled in the computer software arts. Examples of program code include both a machine code, such as produced by a compiler, and a higher-level code that can be executed by the computer using an interpreter.

In the present application (especially, in the appended claims), the use of the terms “the”, “the above-mentioned”, and/or other terms similar thereto can correspond to singular meaning, plural meaning, or both of the singular meaning and the plural meaning as necessary. Also, it should be understood that any numerical range recited herein is intended to include the invention to which the individual values belonging to the range are applied (unless expressly indicated otherwise) and each individual value constituting the range is described in the

### DETAILED DESCRIPTION OF THE INVENTION

The above-mentioned steps constructing the method disclosed in the present disclosure can be performed in a proper order unless explicitly stated otherwise. However, the scope or spirit of the present disclosure is not limited thereto. Further, steps included in the methods according to the present disclosure can be performed through a processor or modules for performing a function of the corresponding step. All examples described herein or the terms indicative thereof (“for example”, “such as”) used herein are merely to describe the present disclosure in greater detail. Therefore, it should be understood that the scope of the present disclosure is not limited to the example embodiments described above or by the use of such terms unless limited by the appended claims. In addition, technical ideas of the present disclosure can also be readily implemented by those skilled in the art according to various conditions and factors within the scope of the appended claims to which various modifications, combinations, and changes are added, or equivalents thereof.

The present disclosure is not limited to the example embodiments described above, and rather intended to include the following appended claims, and all modifications, equivalents, and alternatives falling within the spirit and scope of the following claims.

What is claimed is:

1. A method for dividing a moving space where a mobile robot moves, performed by a processor, the method comprising:
receiving map information of a moving space;
sensing a target object located in the moving space while moving the moving space;
determining whether the sensed target object is a movement obstacle, based on a dataset labeled as a movement obstacle; and
dividing the moving space excluding the movement obstacle from the map.

2. The moving space dividing method according to claim 1, wherein the dividing of the moving space includes:
merging a first moving region and a second moving region adjacent to the first moving region of the plurality of moving regions divided from the moving space, when a merged shape of the first moving region and the second moving region is a triangular shape or a quadrangular shape; and
classifying the merged region as one region.

3. The moving space dividing method according to claim 2, further comprising:
cleaning while moving the moving space,
wherein the cleaning includes:
cleaning one divided region; and
moving to another region after finishing the cleaning of the one region.

4. The moving space dividing method according to claim 3, wherein the cleaning includes:
preferentially cleaning a region having the largest size among the divided regions.

5. The moving space dividing method according to claim 1, wherein the determining of whether to be a movement obstacle includes:
collecting image information of the target object,
confirming that the target object is a movement obstacle by a user;
training a neural network with a dataset labeled as a movement obstacle for image information of the target object confirmed as the movement obstacle; and
generating a determining model for the movement obstacle.

6. The moving space dividing method according to claim 5, wherein the determining of whether to be a movement obstacle further includes:
estimating a volume of the target object, and
the estimating of a volume of the target object includes:
determining whether the volume of the target object is equal to or larger than a predetermined range based on the collected image information of the target object; and
determining the target object as the movement obstacle when it is determined that the volume of the target object is equal to or larger than the predetermined range.

7. A mobile robot which moves a divided moving space, the mobile robot comprising:
a main body of the mobile robot;
a driver which moves the main body;
a sensor which is equipped in the main body, and senses a target object around the mobile robot while moving a moving space;
a moving region setting unit which divides the moving space excluding a movement obstacle into a plurality of moving regions having any one of a quadrangular shape and a triangular shape based on a dataset labeled as the movement obstacle of the sensed target object;
a memory in which the dataset for the movement obstacle is stored; and
a controller which controls the driver by communicating with the memory, the driver, and the moving region setting unit.

8. The mobile robot according to claim 7, wherein the moving region setting unit merges a first moving region and a second moving region adjacent to the first moving region of the plurality of moving regions divided from the moving space, when a merged shape of the first moving region and the second moving region is a triangular shape or a quadrangular shape, and classifies the merged region as one region.

9. The mobile robot according to claim 8, wherein when the mobile robot moves the moving space to clean, after finishing the cleaning of the one region, the mobile robot moves another region to clean.

10. The mobile robot according to claim 9, wherein the mobile robot preferentially cleans a region having the largest size among the divided regions.
